(19) United States
(12) Patent Application Publication
(10) Pub. No.: US 2013/0269649 A1
(43) Pub. Date: Oct. 17, 2013

(54) Inertia Device for Reciprocating Engines

(71) Applicant: James Samuel Flippin, Clearwater, KS (US)

(72) Inventor: James Samuel Flippin, Clearwater, KS (US)

(21) Appl. No.: 13/447,248

(22) Filed: Apr. 15, 2012

(51) Int. Cl. F02B 77/00; F02B 75/32

(52) U.S. Cl. 123/197.1

(57) ABSTRACT

A device for improvement of reciprocating engine efficiency utilizing a free floating weight positioned between compression springs and assembled on each connecting rod. The springs are restrained on the connecting rods at the ends opposite the weights. The weights move on the connecting rods but lag the connecting rod movement because of inertia. The upper and lower springs are alternately compressed and extended due to operating against the weight during engine rotation. The springs are compressed during the deceleration phase of the stroke and extended during the acceleration phase of the stroke. This transfers energy from the deceleration phase to the acceleration phase during engine rotation thereby increasing engine efficiency.

### BACKGROUND OF THE INVENTION

1. Field of the Invention

This invention relates generally to reciprocating engines in which the forces of piston and connecting rod deceleration and acceleration during engine rotation generally cancel each other at the top and bottom of each stroke.

2. Description of Prior Art

Various improvements in engine efficiency are well known and have been highly refined but the relationship between deceleration and acceleration forces have not been fully explored. Various other disclosures include:

U.S. Pat. No. 2,055,588 Johnson
U.S. Pat. No. 4,111,164 Wuerfel

### SUMMARY OF THE INVENTION

The continuing need for increased reciprocating engine efficiency is addressed by the disclosed invention. Accordingly the object of my invention is to increase reciprocating engine efficiency by use of a mechanical device. According to the present invention the described reciprocating engine inertia device is assembled on each connecting rod between the piston and crankshaft. engine inertia device is assembled on each connecting rod between the piston and crankshaft. This inertia device consists of a free floating weight installed between compression springs which are restrained on the connecting rods at the springs outer ends. Spring compression occurs during the deceleration phase of each stroke and the stored energy is released during the acceleration phase of each stroke.

### BRIEF DESCRTIPTION OF THE DRAWING

FIG. 1 is the end view of the inertia device as assembled between the piston and crankshaft of a typical reciprocating engine.

### DETAILED DESCRIPTION OF THE PREFERRED EMBODIMENT

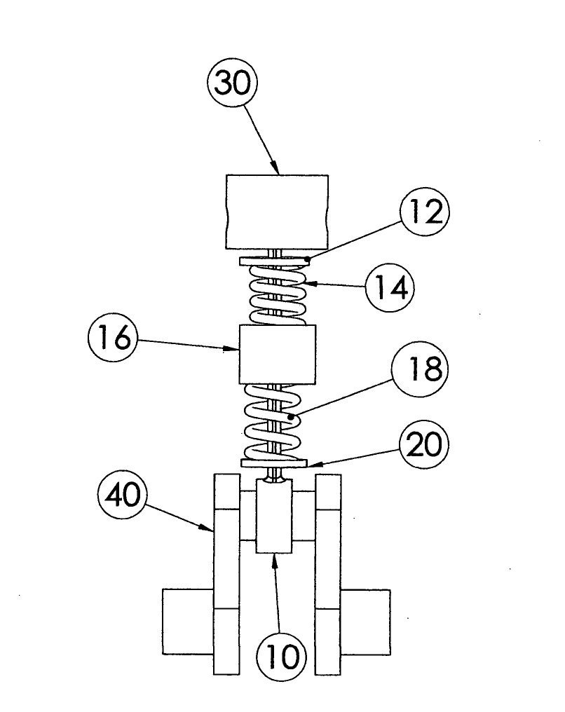

As described above the drawing shows the inertia device and it will be seen and understood by anyone familiar with reciprocating engines that the system includes a piston 30, crankshaft 40 and connecting rod 10. FIG. 1 also shows the restraint 12 for the upper spring, the upper spring 14, the free floating weight 16, the lower spring 18 and the lower spring restraint 20. The springs may also be installed alongside and parallel to the connecting rod for ease of assembly.

I claim:

1. A device for increasing reciprocating engine efficiency comprising:
a free floating weight on each connecting rod having the connecting rod pass parallel, or concentric, to the weight but not fastened directly to the free floating weight,
a free floating weight held generally in position on the connecting rod because of inertia,
a compression spring assembly mounted top and bottom of the free floating weight having the connecting rod pass parallel, or concentric, to the springs,
a restraining device on the ends of the compression springs opposite the free floating weight and fixed to the connecting rod.

2. A device as defined in claim 1, assembled with the reciprocating engine connecting rods and operating in unison with engine rotation to transfer energy from the deceleration phase of the engine stroke to the acceleration phase of the engine stroke for the purpose of increasing engine efficiency.
